(19) United States
(12) Patent Application Publication
(10) Pub. No.: US 2012/0297625 A1
(43) Pub. Date: Nov. 29, 2012

(54) Universal Shaving Instrument

(76) Inventor: Peter Charles Madden, Cincinnati, OH (US)

(21) Appl. No.: 13/427,100

(22) Filed: Mar. 22, 2012

Related U.S. Application Data
(60) Provisional application No. 61/490,491, filed on May 26, 2011.

(51) Int. Cl. B26B 21/08

(52) U.S. Cl. 30/42

(57) ABSTRACT

The shaving instrument has a handle; a pair of elongated arms extending from the handle and having upper portions defining an adjustable cartridge-receiving space there between; a pair of mounts disposed on the upper portions of the arms to engage opposing outer walls of a blade cartridge; a construction for providing a releasable holding force between the mounts and the opposing outer walls; and a construction for controlling pivotal movement of the blade cartridge.

### RELATED APPLICATION

The present application is based upon and claims the priority of U.S. Provisional Application No. 61/490,491 filed May 26, 2011 and entitled “Universal Shaving Razor Handle”.

### BACKGROUND OF THE INVENTION

The present hand-held shaving instrument relates to straight razors adapted to releasably receive a razor blade cartridge, and more particularly to one that can receive a variety of makes and models of blade cartridges.

The typical retailer that carries shaving supplies has a substantial array of shavers and blades for sale. Most, if not all, of the shaver/cartridge combinations have unique interlocking features. When new blade cartridges are needed, the customer usually has to buy a particular type if he or she wants to continue to use a previously obtained shaving instrument. Rarely, if ever, do the replacement cartridges go on sale.

Customers occasionally purchase or receive new shaving instruments and associated blade cartridges without discarding the old shaver and its cartridges. The old and new cartridges and shavers are frequently stored together. When a blade cartridge becomes dull from use and needs to be replaced, the user has to sort through the cartridge supply to find one compatible with the shaving instrument in hand. This task can be tedious—and frustrating if there are no more cartridges compatible with that particular shaving instrument.

Thus the present inventor was faced with the problems of designing a shaving instrument that would accept different makes and models of blade cartridges, that would hold the various cartridges properly in place, and that would enable the blade cartridges to follow the contours of the surface being shaved. It is believed that virtually all commercially produced razor blade cartridges are made with a plastic outer casing and have nearly the same width between the opposing sides. The present shaving instrument takes advantage of these factors to provide sufficient inwardly directed force and penetration to grip the plastic sides, and enough flexibility or range of motion to release the cartridge disposed between the arms.

### SUMMARY OF THE INVENTION

The shaving instrument is adapted to accept a cartridge having at least one pair of opposing outer walls and at least one razor blade extending between the outer walls, and to enable application of the blade cartridge to a shaving surface. The shaving instrument may comprise a handle and a pair of arms extending from the handle. Each of the arms may have an upper portion, and the upper arm portions may define a cartridge-receiving space. Further, the shaving instrument may comprise a mount disposed on each upper arm portion to engage the opposing outer walls of the blade cartridge; a construction for providing a releasable holding force between the mounts and the opposing outer walls; and a construction for controlling pivotal movement of the blade cartridge.

### BRIEF DESCRIPTION OF THE DRAWINGS

FIG. 1 is a front view of an exemplary shaving instrument;

FIG. 2 is a sectional view taken along line 2-2 of FIG. 1 and particularly illustrating the contour of the handle and the arms;

FIG. 3 is a front view of a facial shaving surface;

FIG. 4 is an enlarged fragmentary view of upper portions of the shaving instrument and an uninstalled blade cartridge;

FIG. 5 is a view similar to FIG. 4 with the blade cartridge mounted on the shaving instrument;

FIG. 6 is a further enlarged sectional view taken along line 6-6 of FIG. 5 and illustrates a resting position of the blade cartridge on the shaving instrument;

FIG. 7 is a view similar to FIG. 6 and illustrates the blade cartridge in a relatively pivoted position on the shaving instrument;

FIG. 8 is an enlarged fragmentary front view of components of a first alternative construction for controlling pivotal movement of the blade cartridge;

FIG. 9 is a side view of the components in FIG. 8;

FIG. 10 is a front view of additional components of the first alternative construction;

FIG. 11 is a side view of the additional components in FIG. 10;

FIG. 12 is a fragmentary front view of a second alternative construction for limiting pivotal movement;

FIG. 13 is a fragmentary front view of a third alternative construction for controlling pivotal movement;

FIG. 14 is a side view of the construction in FIG. 13;

FIG. 15 is a fragmentary front view of a fourth alternative construction for limiting pivotal movement;

FIG. 16 is a side view of the construction in FIG. 15;

FIG. 17 is a side view of a first modification of the construction in FIGS. 14 and 15;

FIG. 18 is a side view of a second modification of the construction in FIGS. 14 and 15;

FIG. 19 is a fragmentary front view of a fifth alternative construction for controlling pivotal movement of the blade cartridge;

FIG. 20 is a fragmentary front view of a sixth alternative construction for controlling pivotal movement;

FIG. 21 is a fragmentary front view of a seventh construction for limiting pivotal movement;

FIG. 22 is an exploded front view of the construction in FIG. 21;

FIG. 23 is an exploded front view of an eighth alternative construction for controlling pivotal movement;

FIG. 24 is an exploded front view of a ninth alternative construction for controlling pivotal movement;

FIG. 25 is a fragmentary front view of a first alternative construction for providing a releasable holding force between the mounts and the opposing outer walls;

FIG. 26 is similar to FIG. 25 and includes a ratchet mechanism;

FIG. 27 is a fragmentary front view of a second alternative construction for providing a releasable holding force;

FIG. 28 is a fragmentary front view of a third alternative construction providing a releasable holding force between the mounts and the outer walls of the blade cartridge;

FIG. 29 is a fragmentary front view of a fourth alternative construction providing a releasable holding force;

FIG. 30 is a fragmentary front view of a fifth alternative construction providing a releasable holding force.

FIG. 31 is a fragmentary front view of a second alternative pair of mounts;

FIG. 32 is a further enlarged fragmentary front view of a third alternative mount; and

FIG. 33 is a front view of spike for use with the mount in FIG. 32.

### DETAILED DESCRIPTION OF ILLUSTRATIVE EMBODIMENTS

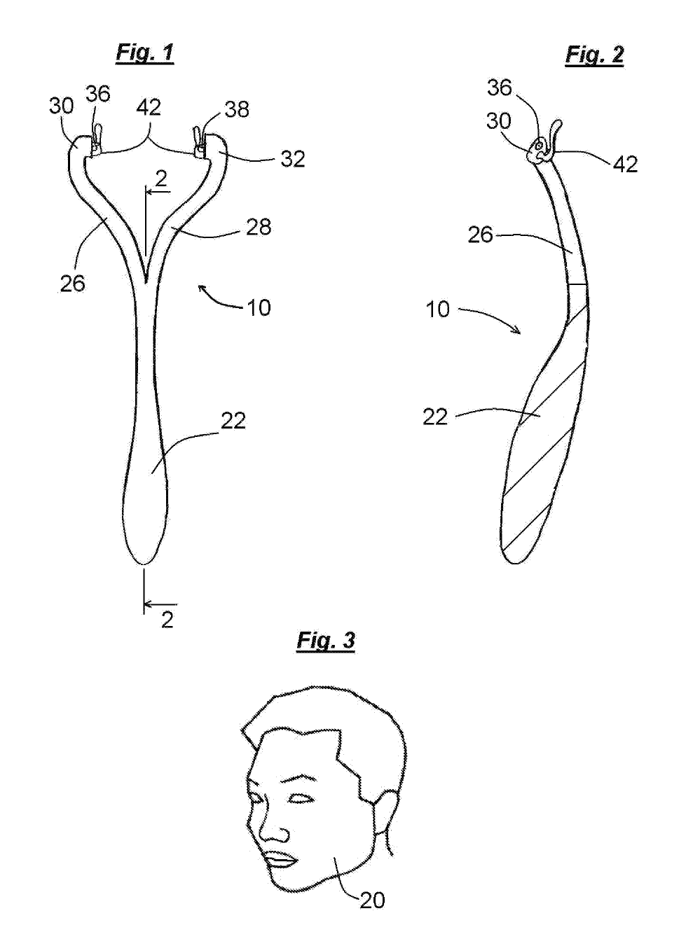

Referring collectively to FIGS. 1-7, the present shaving instrument, generally designated 10, may accept a cartridge 12 having at least one pair of opposing outer walls 14, 16 and at least one razor blade 18 extending between the outer walls, and is adapted to enable application of the blade cartridge to a shaving surface 20. The shaving instrument may comprise a handle 22; a pair of elongated arms 26, 28 extending from the handle and having upper portions 30, 32 defining an adjustable cartridge-receiving space 34A,B there between; a pair of mounts 36, 38 disposed on the upper portions of the arms to engage the opposing outer walls of the blade cartridge; a construction for providing a releasable holding force 40 between the mounts and the opposing outer walls; and a construction for controlling pivotal movement 42 of the blade cartridge.

As further shown in FIGS. 1-7, the cartridge-engaging mounts 36, 38 may be cone-shaped and have tapered or pointed ends 44, 46 (FIG. 3) that contact the outer cartridge walls 14, 16 and enable the cartridge to rotate or pivot thereon.

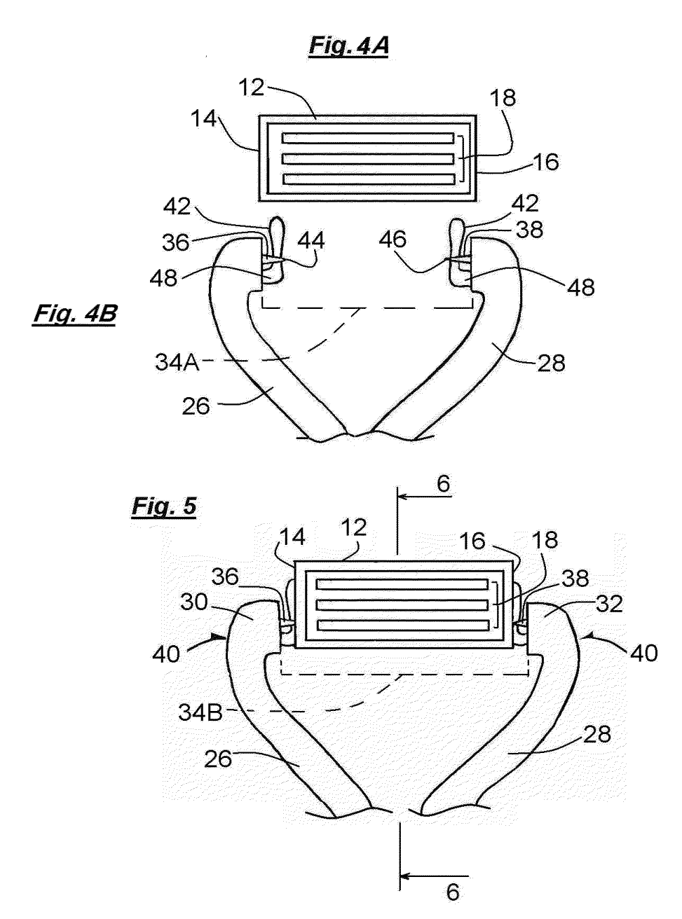

As illustrated in FIGS. 3, 4, the construction providing the releasable holding force 40 between the mounts 36, 38 and the outer cartridge walls may comprise the arms 26, 28 extending from the handle 22 being resilient and disposed so that a space 34A between them when they are in a resting position is less than the distance between the cartridge walls 14, 16. In this manner, the arms may be spread 34B to receive the blade cartridge and, when released, exert the inwardly directed force 40 to hold the mounts in desired locations on the outer cartridge walls during the act of shaving.

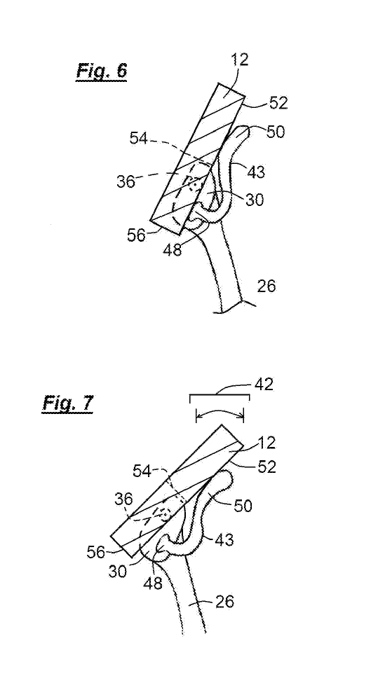

As illustrated in FIGS. 4, 6 and 7, the construction controlling pivotal movement 42 of the cartridge may comprise a pair of cartridge-engaging brackets 43 extending from the upper arm portions 30, 32. Each bracket may be formed with a generally fixed-position base 48 projecting into the space 34A,B below the mounts 36, 38 and with a wing 50 extending angularly from the base. The wings 50 are disposed to engage a back surface 52 of the blade cartridge when the cartridge is in the resting position shown in FIG. 6 and the pivoted position shown in FIG. 7. The pointed ends 44, 46 of the mounts may engage the cartridge walls below their midlines 54 and enable the cartridge to rotate or pivot so that it conforms to the contours of a shaving surface 20 (FIG. 3). When the blade cartridge pivots in a clockwise direction, the resilient bracket wings 50 pivot rearwardly with the cartridge, thereby generating a counterclockwise force that limits clockwise rotation of the cartridge. When the cartridge is pivoted in a counterclockwise direction under the urging of the bracket wings, the back surface 52 engages the bracket bases 48 which act as stops to limit the counterclockwise rotation.

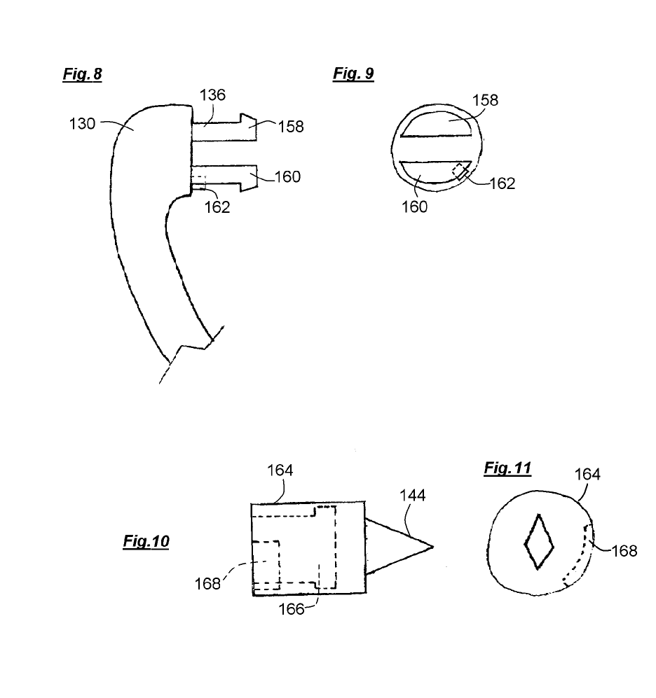

FIGS. 8-11 illustrate a first alternative construction for controlling pivotal movement of the cartridge. The mount 136 comprises a pair of spaced apart prongs 158, 160 projecting inwardly from the upper portions 30 of each arm. A stationary key 162 projects outwardly a short distance from the base of one of the prongs. The prongs may be flexed towards each other. A cap 164 is adapted to be mounted on the The cap is formed with a prong-receiving bore 166, a key-receiving channel 168 and a cartridge-engaging point or tapered end 170. When the cap is mounted on the prongs, the key 162 is disposed in the cap channel 162. Rotation of the cap is limited by the length of the channel 162.

FIG. 12 illustrates a second alternative construction for controlling pivotal movement of the cartridge. The upper portion 230 of each arm may be provided with a rotating mount 236 having a cartridge-engaging point or tapered end. A spring (not shown) or a stop (not shown) may be disposed between the upper portion of the arm and the rotating mount to limit rotation.

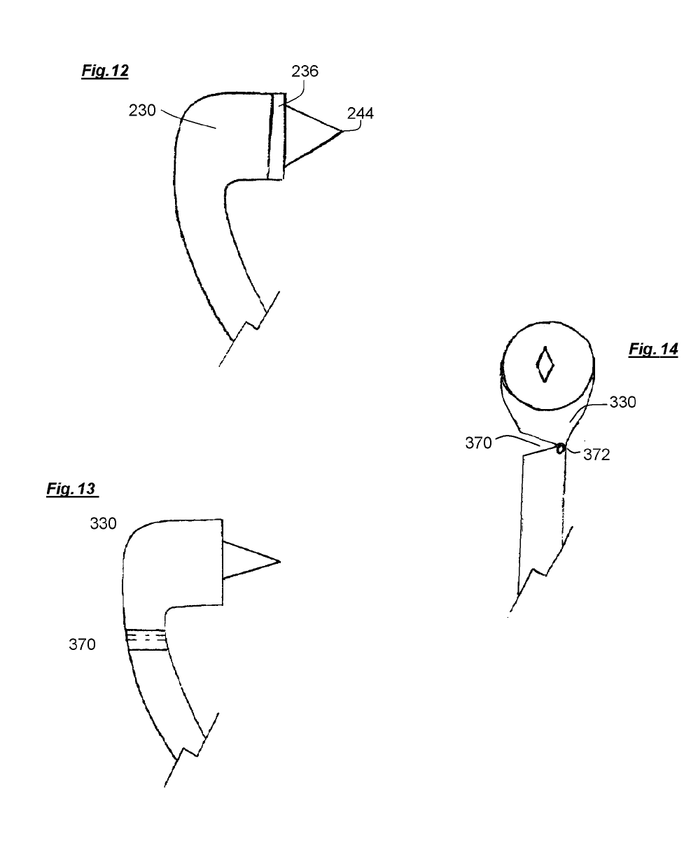

FIGS. 13, 14 illustrate a third alternative construction for controlling pivotal movement of the blade cartridge. A wedge-shaped slot 370 may be formed in each of the arms below the upper portions 330 thereof and a hinge 372 may extend between the upper arm portion to a position below the slot to define a closed end of said slot. The portions of the arms above and below the slot limit the range of rotation around the hinge. Springs (not shown) may be provided to bias the upper portions of the arms to resting positions.

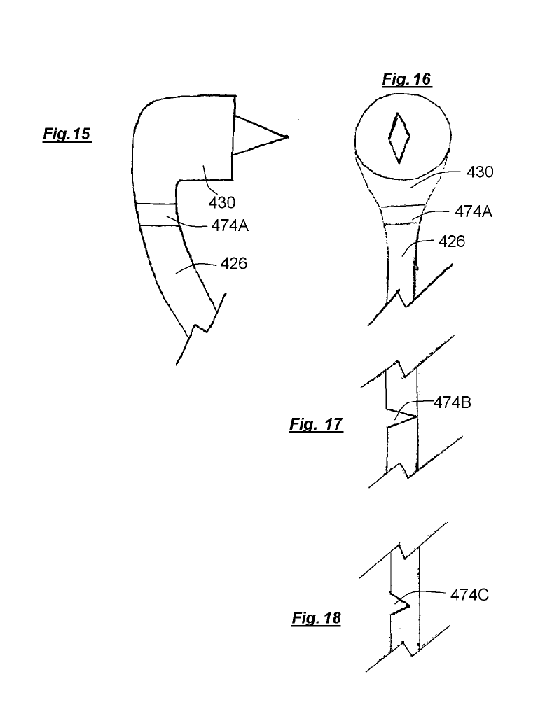

FIGS. 15-18 illustrate a fourth alternative construction for controlling pivotal movement of the cartridge. A flexible segment 174A-C may be provided in each arm 426 below the upper portion 30. The segment 174A may be disc-shaped, and separate the upper portion from the rest of the arm as illustrated in FIGS. 14,15, or wedge-shaped 174B and extend substantially through the arm as illustrated in FIG. 16, or wedge-shaped 174C and extend partially through the arm, as illustrated in FIG. 17. The upper end if each arm, and hence the blade cartridge, is thereby provided with limited pivot movement

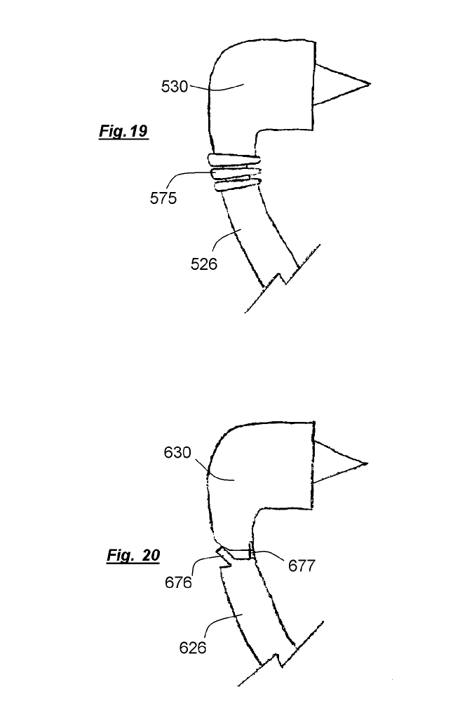

FIG. 19 illustrates a fifth alternative construction for controlling pivotal movement. An accordion or spring segment 175 may be disposed between the upper portion 30 and the rest of the arm 526.

FIG. 20 illustrates a sixth alternative construction for controlling pivotal movement. A cam 176 and a lever 177 may be disposed between the upper portion 30 and the rest of the arm 16. The upper arm portion pivots on the cam within limits provided by the lever. In this manner, the blade cartridge movement is controlled.

FIGS. 21, 22 illustrate a seventh alternative construction for controlling pivotal movement. A flanged socket 178 may be formed at the lower end of the upper portion 730 of each arm, and a peg 179 may be formed on the upper end of each arm. The socket and peg are cooperatively formed to snap fit together. A stop 180 may be formed on the arm below the peg to limit pivotal movement of the upper arm portion 730 and the blade cartridge.

FIG. 23 illustrates an eighth alternative construction for controlling pivotal movement. A socket or cough 181 may be formed at a lower end of an upper mount-bearing portion 830 and a ball or peg 182 may be formed on an upper end of each arm 626. A ball-engaging spring may be mounted in the upper end adjacent to the cough to bias and smooth movement of the upper portion. The internal design of the cough and ball dictate the range and direction of pivot movement.

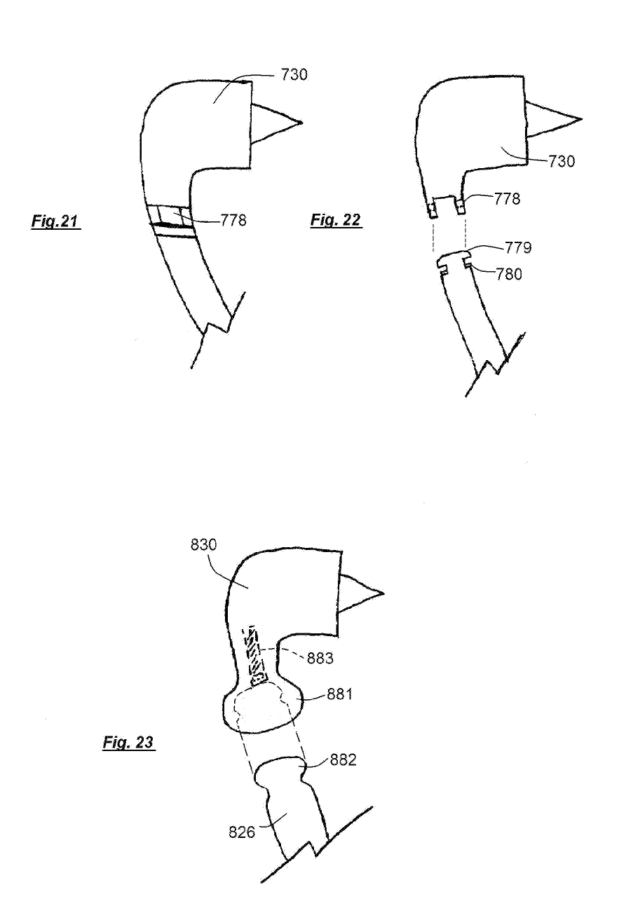

FIG. 24 illustrates a ninth alternative construction for controlling pivotal A handle 922 is formed with a peg or ball at its upper end, and the arms 926, 928 are joined together at their lower ends. A cough or socket 923 is formed in the junction portion of the arms. The internal design of the ball and cough dictate the range and direction of motion of the arms. A ball-engaging spring (not shown) may be provided adjacent to the ball to urge or bias the arms to a resting position.

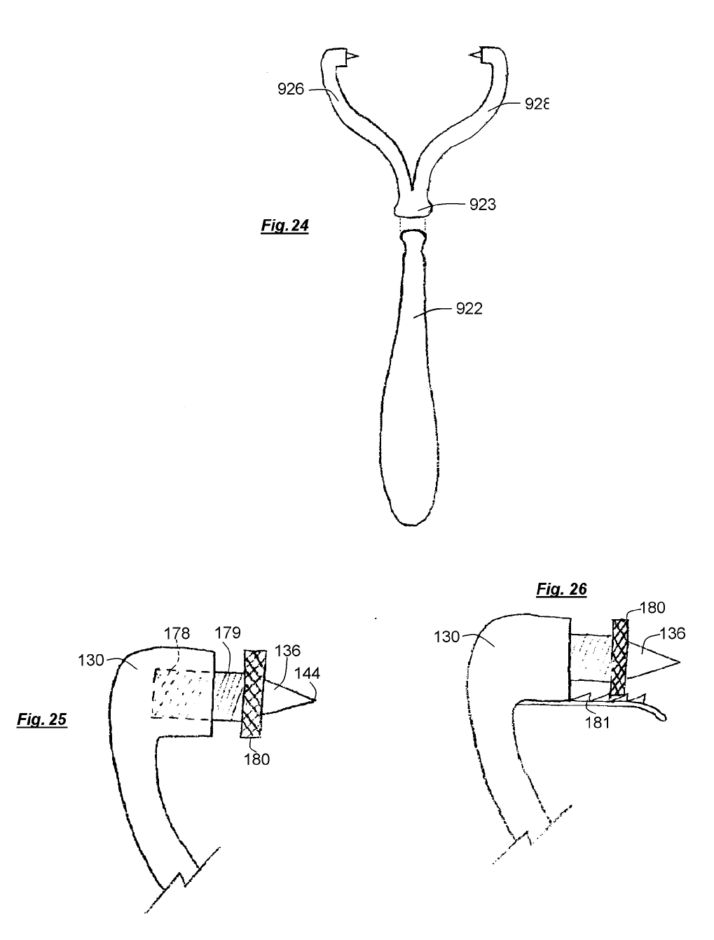

FIGS. 25, 26 illustrate a first alternative construction for releasably holding the blade cartridge between the arms and a first alternative mount 136. A threaded socket 178 is provided in the upper portion 130 of each arm and the mount 136 has a cooperatively threaded base 179. In this manner, the point 144 on the mount may be tightened against or loosened from the cartridge by rotating the base by means of a knurled knob 180. A ratchet 181 may extend inwardly from the upper portion 130 of each arm to engage a knob 180 to impede rotation.

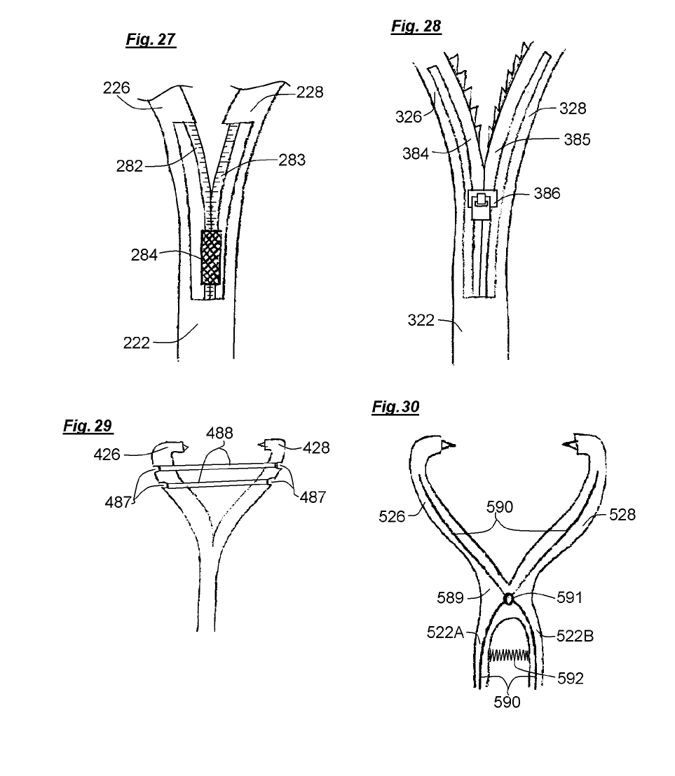

FIG. 27 illustrates a second alternative construction for releasably holding the cartridge between the mounts. The arms 226, 228 may be provided with flexible threaded shafts 282, 283 adjacent to the handle 222. An internally threaded cylinder 284 may be rotatably mounted on the threaded shafts. Rotation of the cylinder in one direction advances it along the threaded shafts, thereby drawing them together. In this manner, the mounting members are urged against the blade cartridge. When the cylinder is rotated in the opposite direction, the threaded shafts separate, thereby moving the mounts away from the cartridge.

FIG. 28 illustrates a third alternative construction for releasably holding the cartridge between the mounts. The arms 326, 328 may be provided with zipper members 384, 385 adjacent to the handle 322 and with a slide 386 mounted on the zipper members. When the slide is moved up, the zipper members are drawn together, thereby urging the mounting members against the blade cartridge. When the slide is lowered, the zipper members separate, thereby moving the mounts away from the cartridge.

FIG. 29 illustrates a fourth alternative construction for releasably holding the cartridge between the mounts. The arms 426, 428 may be formed with grooves 487 in their lateral surfaces, and elastic bands 488 may be mounted in the grooves and extend between the arms. The bands are sized to draw the arms together, thereby urging the mounts against the blade cartridge. The bands may be removed or the arms drawn apart by hand to release the cartridge from the mounts.

FIG. 30 illustrates a fifth alternative construction for releasably holding the blade cartridge between the mounts. The lower ends of the handle 522A, 522B are bifurcated and a junction 589 is provided between the handle segments and the arms 526, 528. Hard internal core strips 590 extend along the arms and the handle segments. At the junction, the core strips are connected to a fulcrum 591. An optional spring 592 may extend between the handle segments. When the handle segments are squeezed together, the arms, and hence the mounts, move apart to release the blade cartridge. When the handle segments are release and separated, the mounts hold the cartridge in place.

FIG. 31 illustrates a second alternative pair of mounts 236, 238. The mounts may be rotatably mounted on the upper ends 230, 232 of the arms. Serrated edges 294 may be formed on the cartridge-engaging ends of the mounts. When the blade cartridge is inserted between the mounts, they rotate inwardly to a closed position, thereby increasing the force exerted on the cartridge. A catch (not shown) may be provided to lock the mounts in the closed position, and a release lever 295 may be provided to withdraw the cartridge.

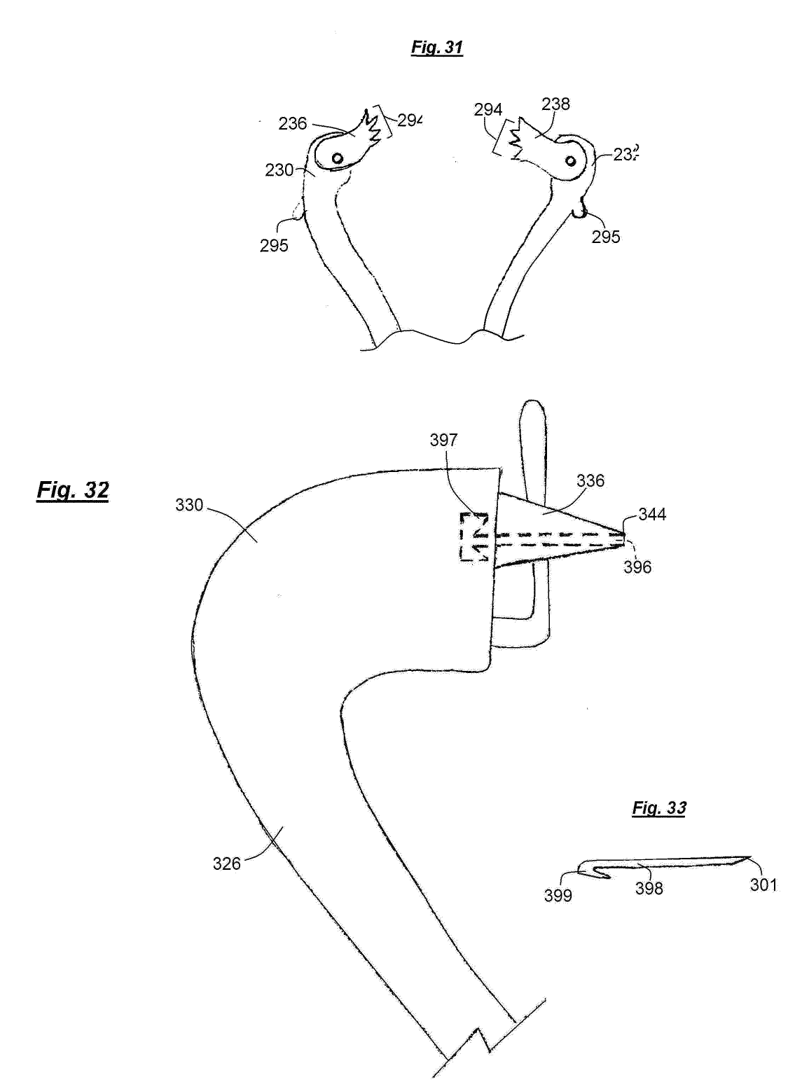

FIGS. 31, 32 illustrate a third alternative mount 336. The mount may be conical in shape and formed with spike-receiving bore 396 extending from a tip 344 of the mount to a recess 397 in an upper end 330 of the arm 326. A spike 398 may be inserted into the bore. A hook 399 may be formed on one end of the spike. Upon insertion of the spike in the bore, the hook may be captured in the recess. A sharp point 301 may be formed at the opposite end of the spike and project slightly beyond the tip of the mount to penetrate the cartridge wall. The spike may be able to rotate in the mount bore and the arm recess so that pivotal movement of the cartridge is not impeded.

The cartridge-engaging mounts may have additional alternative configurations. By way of example, not limitation, each mount may have multiple cartridge-engaging points or no points at all. In the latter case, the mount may have a cylindrical end on which a cartridge-engaging friction pad is provided. The pad may be smooth or ribbed, and it may be formed with a circular or semi-circular cartridge-engaging surface.

The foregoing description and the illustrations of various embodiments of the shaving instrument are presented to enable fabrication and use upon patent expiration and not to unduly limit the scope of the following claims.

1. A shaving instrument adapted to accept a cartridge having at least one pair of opposing outer walls and at least one razor blade extending between said walls and to enable application of said blade cartridge to a shaving surface, said shaving instrument comprising:
a handle;
a pair of arms extending from the handle, each of said arms having an upper portion, said upper arm portions defining a cartridge-receiving space there between;
a mount disposed on each upper arm portion to engage the opposing outer walls of the blade cartridge;
means providing a releasable holding force between the mounts and the opposing outer walls; and
means controlling pivotal movement of the blade cartridge.

2. The shaving instrument according to claim 1, wherein the mounts are cone-shaped and have tapered ends for contacting the outer cartridge walls and enabling the cartridge to rotate or pivot thereon.

3. The shaving instrument according to claim 1, wherein the means for releasably holding the mounts against the opposing outer walls of the blade cartridge comprise the pair of arms extending from the handle being resilient and having resting positions and further comprising the space between the upper arm portions with said arms in resting positions being less than the distance between the opposing cartridge walls.

4. The shaving instrument according to claim 1, wherein the means for controlling the pivotal movement of the cartridge comprise a pair of cartridge-engaging brackets extending from the upper portions of the arms.

5. The shaving instrument according to claim 4, wherein each of the cartridge-engaging brackets is provided with a generally fixed position base and a resilient wing extending angularly from said base.

6. The shaving instrument according to claim 4, wherein the brackets engage a back surface of the blade cartridge and hold the cartridge in a resting position suitable for engaging the shaving surface.

7. The shaving instrument according to claim 5, wherein the resilient wings on the brackets exert a counterforce against clockwise rotation of the cartridge.

8. The shaving instrument according to claim 5, the blade cartridge is mounted on said shaving instrument with a lower wall of said cartridge adjacent to the bases of the brackets.

9. The shaving instrument according to claim 1, wherein the means for controlling pivotal movement of the blade cartridge comprises a pair of flexible prongs and a stationary key projecting from each of the upper arm portions and a cap mountable on said prongs and provided with a key-receiving channel, said cap being pivotable on the prongs and said pivotal movement being limited by said key-receiving channel.

10. The shaving instrument according to claim 1, wherein the means for controlling pivotal movement of the blade cartridge comprises a wedge-shaped slot formed in each of the arms below the upper arm portions and a hinge defining a closed end of the slot.

11. The shaving instrument according to claim 1, wherein the means for controlling pivotal movement of the blade cartridge comprises a flexible segment provided in each arm below the upper portion thereof.

12. The shaving instrument according to claim 11, wherein the flexible segment is accordion-shaped.

13. The shaving instrument according to claim 1, wherein the means for controlling pivotal movement of the blade cartridge comprises a cam and a lever mounted on the arm below the upper portion thereof.

14. The shaving instrument according to claim 1, wherein the means for controlling pivotal movement of the blade cartridge comprise a socket provided on a lower end of each of the upper arm portions and a peg positioned on each of the arms below the socket, said peg being releasably mountable in said socket.

15. The shaving instrument according to claim 1, wherein the means for controlling pivotal movement of the blade cartridge comprises a socket provided below a junction between the arms and a peg provided on an upper end of the handle, said peg being releasably mountable in said socket.

16. The shaving instrument according to claim 1, wherein the means providing a releasable holding force between the mounts and the opposing outer walls of the blade cartridge comprises a threaded socket provided in each of the upper arm portions and a cooperatively threaded mount movable in each of the sockets.

17. The shaving instrument according to claim 16, wherein a ratchet is disposed on each of the upper arm portions adjacent to the threaded socket to engage the mount.

18. The shaving instrument according to claim 1, wherein the means providing a releasable holding force comprises a threaded shaft mounted on each of the arms and an internally threaded cylinder rotatably mounted on the threaded shafts.

19. The shaving instrument according to claim 1, wherein the means providing a releasable holding force comprises a zipper-like strip mounted on each of the arms and a slide mounted on the zipper-like strips.

20. The shaving instrument according to claim 1, wherein the means providing a releasable holding force comprises at least one pair of opposing grooves formed in the arms and an elastic band mounted in the grooves.

21. The shaving instrument according to claim 1, wherein the means providing a releasable holding force comprises a two-piece handle and a rotatable junction between said handle pieces and the arms.

22. The shaving instrument according to claim 1, wherein the mounts are rotatably mounted on the upper arm portions.

23. The shaving instrument according to claim 1, wherein each mount is provided with a bore and a pin rotatably mounted in the bore, said pin having a pointed, cartridge-engaging end projecting out of the mount.
